(19) United States
(12) Patent Application Publication
(10) Pub. No.: US 2005/0038699 A1
(43) Pub. Date: Feb. 17, 2005

(54) System and method for targeted advertising via commitment

(76) Inventors: Mark David Lillibridge, Mountain View, CA (US); Rajan Mathew Lukose, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/909,161

(22) Filed: Jul. 30, 2004

Related U.S. Application Data
(63) Continuation-in-part of application No. 10/639,140, filed on Aug. 12, 2003.

(51) Int. Cl. G06F 17/60

(52) U.S. Cl. 705/14

(57) ABSTRACT

The disclosed embodiments relate to a system and method of advertising. The method may comprise sending a targeted advertisement to at least one of a plurality of computers, wherein the targeted advertisement comprises a query. Further, the method may comprise receiving a proof after sending the targeted advertisement, wherein the proof relates to an earlier commitment of a profile of data stored on one of the plurality of computers, and using the proof to determine that the committed profile satisfied the query.

### CROSS REFERENCE TO RELATED APPLICATION

This application is a continuation-in-part of U.S. patent application Ser. No. 10/639,140, by Rajan M. Lukose and Joshua R. Tyler, entitled “Targeted Advertisement with Local Consumer Profile,” filed on Aug. 12, 2003.

### BACKGROUND OF THE RELATED ART

The Internet couples millions of computers together and provides computer users with a variety of capabilities. For example, using the Internet, computer users may view text and graphics, make purchases, send and receive electronic mail, and search for information. As a result, the Internet has become a valuable tool of commerce and communication. Accordingly, advertising on the Internet has developed into a significant market. Common types of Internet advertisement services include “spam” email (i.e., unsolicited commercial email), pop-up advertisement banners, and consumer profiling (i.e., tracking and selling consumer information including Internet activities).

Unfortunately, there are many shortcomings in these Internet advertisement services. These common types of Internet advertisement may fail to match up advertising with willing recipients having the targeted profiles. For example, spam email and advertisement banners may not effectively target consumers and can be highly inefficient in terms of generating favorable responses for advertisers. An additional problem is that consumer profiling may encroach on consumer privacy and thus reduce willing participation. Advertisers and consumers, among other entities, need a system or method that may permit advertisers to find consumers that match a desired consumer profile, while permitting consumers to control their own personal information.

### BRIEF DESCRIPTION OF THE DRAWINGS

For a detailed description of embodiments of the present invention, reference will now be made to the accompanying drawings in which:

FIG. 1 shows a block diagram of a computer system in accordance with embodiments of the present invention;

FIG. 2 shows a block diagram illustrating an advertising system in accordance with embodiments of the present invention;

FIG. 3 shows a process flow diagram illustrating a method for advertising in accordance with embodiments of the present invention; and

FIG. 4 shows a process flow diagram illustrating a method for advertising in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

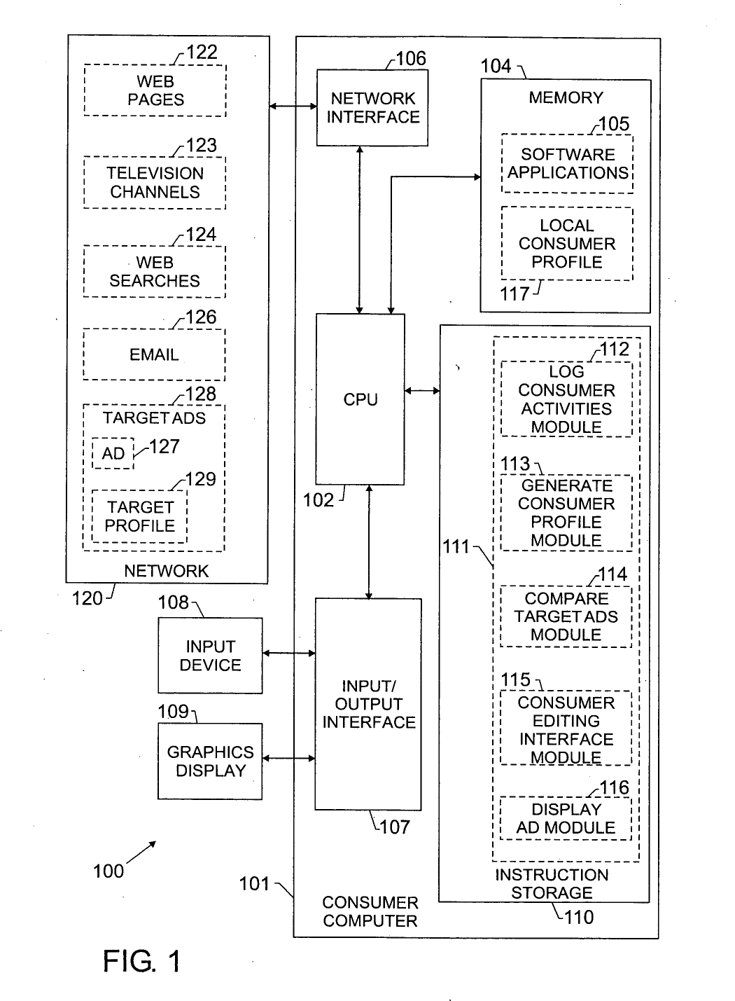

FIG. 1 shows a block diagram of a system 100 in accordance with embodiments of the present invention. The system may incorporate various modules. However, while FIG. 1 separately delineates specific modules, in other embodiments, individual modules may be split into multiple modules or combined into a single module. Additionally, each module may represent hardware, software, or some combination thereof.

As shown in FIG. 1, the system 100 may comprise a consumer computer 101 coupled to a network 120, an input device 108, and a graphics display 109. In some embodiments of the present invention, the computer 101 may be a processor based unit such as a smart television (e.g., television with a processor) or a plurality of consumer devices acting in concert. The consumer computer 101 may comprise a CPU (central processing unit) 102 coupled to a memory 104, a network interface 106, an input/output interface 107, and an instruction storage medium 110. Each of the instruction storage medium 110 and memory 104 may comprise any of a variety of media for storing computer-readable instructions. Examples of a suitable instruction storage medium 110 include, a floppy disk, a compact disk, a volatile memory, a non-volatile memory, a hard drive, or a combination thereof. In at least some embodiments, the memory 104 and the instruction storage medium 110 may be the same. The memory 104 may store instructions that comprise software applications 105 and data that comprises a local consumer profile 117, for example.

As shown in FIG. 1, the network 120 couples to the consumer computer 101 through a network interface 106. The consumer computer 101 may receive electronic content such as web pages 122, television channels 123, search engine results 124, email 126, and targeted advertisements (“ads”) 128 from the network 120. The network 120 may represent various types of networks. For example, the consumer computer 101 may receive content from a cable television network, a satellite television network, an Internet network, or the like. In at least some embodiments, a user of the consumer computer 101 may specify, through the network interface 106, the content that the consumer computer 101 receives from the network 120 by inputting information (e.g., Internet domain names, television channels) using an input device 108, which may comprise a keyboard, a mouse, and so forth. Additionally, a network owner or server may limit content available from the network 120 (e.g., the Internet).

The instruction storage medium 110 provides computer-readable instruction modules 111 capable of execution by the CPU 102 to enable the consumer computer 101 to perform various functions. As shown, the computer-readable instruction modules may comprise modules of software that log consumer activities (module 112), generate a consumer profile (module 113), compare target ads to the consumer profile (module 114), edit the consumer profile (module 115), and display an advertisement (module 116).

More specifically, module 112, which logs consumer activities, may comprise code that targets and recognizes when certain computer activities occur. For example, module 112 may systematically sample the operation of CPU 102 and/or network interface 106 to recognize the software applications 105 that are used, web pages 122 that are accessed, time spent browsing those web pages 122, web searches 124 that are performed, and email 126 usage or the like. Additionally, module 112 may function with the CPU 102 and the memory 104 to store information regarding the software applications 105 that are used, web pages 122 that are accessed, time spent browsing those web pages 122, the web searches 124 performed, and email 126 usage and the like. For example, one embodiment of the present invention may monitor and log television stations and programs that are displayed on computer 101 along with the amount of time each television station or program is displayed. Some embodiments of the present invention monitor and store information regarding peripheral devices either over the network 120 or through a direct connection 108. For example, a printer connected to computer 101 may require ink and a corresponding status (e.g., “requires ink”) may be detected by module 112 and used as a consumer activity or consumer profile aspect.

Module 113, which generates consumer profiles, may work with module 112 to enable the consumer computer 101 to organize the consumer activities information acquired as described above. For example, module 113 may generate a database, data structure, or the like from the stored consumer activities information so that an inquiry regarding specific consumer activities may be made by accessing and searching the database. As shown in FIG. 1, a local consumer profile 117 may be generated by module 113 and stored in the memory 104.

Module 114, which compares target ads, may provide a local, secure interface so that target profiles 129 embedded in a target ad 128 and received by the consumer computer 101 may be compared to the local consumer profile 117 stored in the memory 104 without compromising consumer privacy. Module 115 may facilitate editing the consumer profile and may enable an operator of the computer 101 to make changes to the local consumer profile 117. For example, it may be desirable for an operator of the computer 101 to delete and/or add information to the local consumer profile 117 or portions of the local consumer profile 117. Therefore, module 115 may open a window that permits the operator to view information in the profile 117 and make changes to the profile 117 or merely inspect the profile 117. Additionally, in some embodiments of the present invention, module 115 may not allow editing but only deletion of certain profile 117 aspects (e.g., a user may delete visited websites but not edit them, or a user may only edit demographic data and not software usage).

Module 116, which facilitates displaying an ad, may work with module 114 to present an advertisement 127 to an operator of the computer 101 when a predetermined amount of target consumer activities of the target profile 129 are contained in the local consumer profile 117 or when a consumer profile meets requirements of the target profile (e.g., using comparison methods other than simply matching positive aspects). For example, module 116 may enable a pop-up advertisement or another advertisement to be displayed on the graphics display 109. In a specific example, module 116 may enable an advertisement for ink to be displayed in a pop-up advertisement on the graphics display 109 if the consumer profile indicates that a printer attached to the computer 101 requires an ink cartridge replacement.

In general and in accordance with some embodiments of the present invention, a computer 101 comprises a monitor 109, a CPU 102, memory 104 coupled to the CPU 102, and an instruction storage medium 110 coupled to the CPU 102. The instruction storage medium 110 may cause the computer 101 to log computer activities, create a local consumer profile that comprises a first set of information, receive a targeted advertisement containing a second set of information, and compare the first set of information to the second set of information. If certain information from the second set of information matches with the first set of information, the targeted advertisement may be presented on the computer 101.

The local consumer profile 117 may comprise user-specified criteria pertaining to which advertisements the user of a computer wishes to be shown on the computer 101. If the targeted ad 128 does not contain information that falls within the user specified criteria, that targeted ad may be precluded from being displayed to the user. The user specified criteria stored in the local consumer profile 117 may comprise an inventory of logged user activities. Additionally, or alternatively, user specified criteria may comprise a consumer ask price. The consumer ask price may be adjustable and set by the consumer as a minimum price that advertisers pay to the consumer for his/her attention to an advertisement. The consumer ask price may be an amount of money, or some other reward such as coupons, points that may be used to make purchases, airline miles, free gifts, or the like. The consumer ask price may allow the consumer to control the value of his/her attention to an advertisement and may discourage advertisers from sending unsolicited advertisements by requiring the advertiser to pay each consumer for his/her attention to an advertisement at a price controllable by the consumer.

In embodiments of the present invention that use both consumer activities and a consumer ask price for the local consumer profile 117, the target profile 129 may comprise a set of target consumer activities and a bid price. If the set of target consumer activities (second set of information) matches a minimum amount of consumer activities (first set of information) stored in the local consumer profile 117 and the bid price is greater than or equal to the consumer ask price, then the ad 127 may be presented to the operator of the consumer computer 101 through the graphics display 109. An advertiser may define the content of the ad 127, the target profile 129, and ad display type (e.g., pop-up, flashing icon, or the like) to suit their particular needs.

In at least some embodiments, the computer-readable instruction modules 111 may execute on the CPU 102 in the background of the consumer computer 101. For example, the log consumer activities instructions 112 may enable the consumer computer 101 to track transparently a wide variety of consumer activities such as usage of the software applications 105, web pages 122 visited, time spent on those web pages, web searches 124 performed, and email 126 usage. As previously explained, some or all of the logged information may be included in the local consumer profile 117.

The input device 108, the graphics display 109, and the consumer editing interface 115 allow the operator of the consumer computer 101 to control the information stored in the local consumer profile 117. For example, a particular consumer may view his/her local consumer profile 117, and modify the profile by deleting information in the profile 117 and/or adding information to the profile 117. Accordingly, the local consumer profile 117 may contain only those elements that the consumer wants to make available for comparison with the targeted ads 128. In some embodiments, a consumer may not add information to his/her profile 117, as it may be desirable to protect the validity of consumer activities stored in the profile 117. Furthermore, in some embodiments, a consumer may not edit the profile 117, but may still choose to enable or disable the function of the instruction modules 111 as described above. For example, the instruction modules 111 may not necessarily provide a user interface whereby the profile 117 is editable. In embodiments where the profile 117 is not editable, code obfuscation (i.e., intentionally making the source code hard to understand) may be used to prevent software hackers from accessing and/or editing the profile 117. Additionally, some computers 101 may use special hardware or software that would prevent the profile 117 from being manipulated in some ways. One example of such an approach may be performed by a system that complies with a standard known as the Trusted Computing Platform (“TCP”), which is promulgated by the Trusted Computing Group.

By keeping the local consumer profile 117 on the consumer computer 101 (e.g., in the memory 104), consumer privacy is maintained while allowing the consumer to receive advertisements for products and services that may be of interest to the consumer based on information in the local consumer profile 117. In at least some embodiments, advertisers do not know when the targeted ads 128 match the consumer profile 117. In some embodiments of the present invention, only when consumers choose to view an ad 127 is it possible for information about the profile 117 to be released to an advertiser.

The release of personal information may be controlled in several ways, including, but not limited to, sending an ad 127 that is viewable by the consumer without accessing an outside server. If the ad 127 is viewed by accessing an outside server, for example, accessing a universal resource locator (“URL”), the owner of the outside server may be entrusted not to reveal information about accesses to advertisers. Other techniques such as data encryption protocols or cryptographic protocols may also be employed.

For example, module 116 may enable the computer 101 to provide an icon on the graphics monitor 109 that shows a value meter of incentives that are waiting to be claimed by viewing advertisements 127. By double-clicking on the icon, the instruction modules 111 may cause an application with a viewable window to appear wherein the consumer may view details of a targeted ad 128, such as sponsor, available reward, advertisement type (e.g., video, web page, text), an advertisement link, an expiration date of the offer, and target profile information. By clicking on the advertisement link, the consumer may be shown the advertisement 127. After viewing the advertisement 127, the application window may display a summary of earned incentives. The application window may also provide the consumer with a method of inputting the consumer ask price, a method for collecting the incentive (e.g., direct deposit to a bank account, links to websites where coupons are redeemed or where purchase points and/or airline miles are stored), or the like.

As previously mentioned, the system 100 may permit advertisers to target consumers with a targeted ad 128. In at least some embodiments, the targeted ads 128 may be viewable only by a computer 101 with certain of the instruction modules 111 installed. In such embodiments of the present invention, a public/private key pair encryption system that encrypts the targeted ads 128 may be used to ensure that a particular computer 101 is able to view the targeted ads 128. For example, a public key may be used to encrypt a message and a private key or secret key known only to the recipient may be required to decrypt the message. Therefore, consumers may be enticed to purchase an instruction storage medium 110, or a computer 101, with the instruction modules 111 so that they can use the system 100 to receive incentives from advertisers.

As an example of a potential targeted advertising scenario, an advertiser may be in search of a consumer who has at least twice (e.g., separated in time by at least 5 hours) spent time on three web sites (X, Y, Z) related to automobiles, and has viewed web pages describing sport utility vehicles (SUVs) made by automobile companies A and B. The advertiser may further require that the consumer has done an Internet search during the last three weeks containing the terms “SUV” and “safety”, but has never visited the website of automobile company C, who also makes SUVs.

The advertiser (for example, automobile company C) may be willing to pay, for example, $3 to a consumer for his/her attention, if the above criteria are met. Therefore, the advertiser would generate a target ad 128 in which the target profile 129 contains criteria corresponding to the website visits, the web searches, and time requirements specified above. The target profile 129 may also include a bid price of $3. At the consumer computer 101, the target ad 128 is received, and the target profile 129 is compared to the local consumer profile 117 using module 114. If the above criteria of target profile 129 is satisfied by the local consumer profile 117, the ad 127 would be displayed on the graphics display 109 using module 116. As previously explained, the target profile 129 may include a bid price and the local consumer profile 117 may include a consumer ask price. In the above example, the consumer ask price would need to be $3 dollars or less for the ad to be displayed (assuming the advertiser submitted a bid price of $3). The consumer may be a discriminating consumer who dislikes unsolicited advertisements, and may accordingly set his/her consumer ask price at a higher price. Therefore, only the targeted ads 128 that include a bid price incentive of at least the consumer ask price will be displayed to the consumer, even if the target consumer activities included in the target profile 129 are found in the local consumer profile 117.

The advertisement 127 of a targeted ad 128 may also be customized to the consumer. As an example, an advertisement 127 based on the criteria given above may include the statement, “Reasons why SUVs of automobile company C are superior to the SUVs of automobile companies A and B”. Given the consumer's recent behavior and the cash incentive, the consumer may be willing to spend time to view the advertisement.

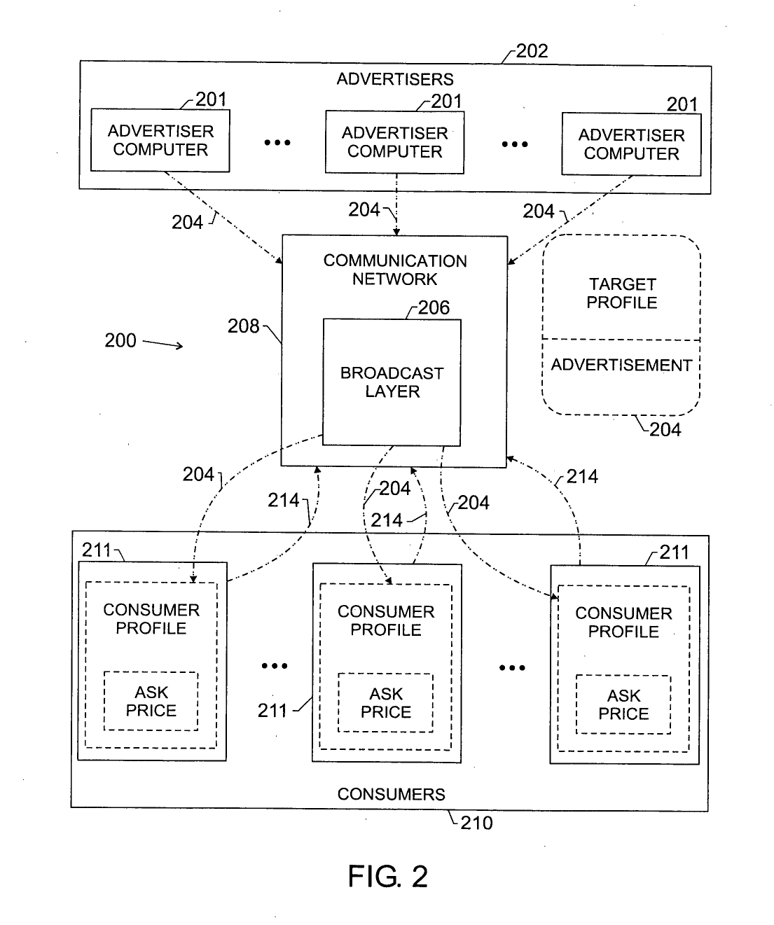

FIG. 2 shows a block diagram illustrating a system 200 in accordance with embodiments of the present invention. As shown in FIG. 2, the system 200 may comprise a plurality of advertiser computers 201 and consumer computers 211 coupled to each other through a communication network 208 (e.g., the Internet) having a broadcast layer 206. The advertisers 202 may use the computers 201 to send advertisement messages 204 to the communication network 208. It should be noted that, in some embodiments of the present invention, advertisers and/or users may be required to authenticate themselves in order to participate. This type of authentication may, for example, prevent advertisers from participating when they that have not paid a required fee or untrustworthy users from receiving ads.

Each advertisement message 204 may comprise a target profile and an advertisement. As previously explained, the target profile may comprise a set of target consumer activities and a bid price. In at least some embodiments, the communication network 208 may be a server that broadcasts targeted ads 204 to the consumer computers 211. As shown in FIG. 2, each consumer computer 211 may contain a consumer profile and an ask price. In at least some embodiments, the network 200 may be combined with existing spam blocking tools, whereby unknown advertisers would pay the consumers 210 for their attention to advertisements. Additionally, advertisers and/or consumers may pay the network manager or server owner for providing the gateway and/or services associated with embodiments of the present invention. In some embodiments, the network manager or server owner may impose conditions on potential ads (e.g., no sexually explicit ads or no ads from non-paying advertisers).

The broadcast layer 206 may be one of, or a combination of several possibilities that include, but are not limited to, a direct server to PC (personal computer) connection over the Internet, an indirect connection through a peer-to-peer scheme (i.e., each party may control initiation of a communication session), or a datacasting method (i.e., satellite communications) that broadcasts a digitized advertisement message 204 over a television infrastructure. The communication network 208 may send the advertisement messages 204 to all or some of the consumer computers 211 using the broadcast layer 206.

As set forth above, the consumers 210 may control participation in the network 200. For example, a consumer may disable the consumer profile on his/her computer 211. In contrast, the consumer profile may be configurable, whereby an operator of a computer 211 may change his/her consumer profile, including an ask price. An operator also has the option of simply not responding to advertisements that match the consumer profile. If a required portion of the target profile of an advertisement message 204 matches a consumer profile, a consumer 210 may choose to view or not view the advertisement attached or otherwise included with the advertisement message 204. In at least some embodiments, the advertisement of an advertisement message 204 may comprise an Internet hyperlink that permits the user to view the advertisement on the Internet by sending a response 214 to the communications network 208.

There are at least two methods of controlling the amount of incentives that a consumer receives for viewing an advertisement. These methods may relate to a user-designated ask price (referred to in the following example by reference letter A) and an advertiser designated bid price (referred to in the following example by reference letter B). In general, regarding the first method, a function V(A, B) that describes the relationship between consumer ask price (A) and bid price (B) may be included in the advertisement message 204 or the instruction modules 111 (FIG. 1). For example, if A=$3 and B=$5, V(A, B) determines whether the consumer receives $3 or $5 or something in between. If V(A, B)=A, then a consumer only receives the consumer ask price A for viewing an advertisement, even if B is more valuable then A. However, if V(A, B)=B, the consumer receives the bid price B for viewing an advertisement. Using a V(A, B)=A relationship may encourage a consumer to set his/her ask price A high enough to make viewing advertisements worthwhile. For example, a consumer who sets the consumer ask price A at $0, will not receive any incentive for viewing ads attached to an advertisement message 204 if the V(A, B)=A relationship is used.

Alternatively, in the second method, a function T(V(A, B)) may be programmed into the advertisement messages 204 or the instruction modules 111 (FIG. 1). The function T(V(A, B)) may be the same as V(A, B) explained above except that a portion of any incentive offered by an advertiser to a consumer may be given to the owner of network 208. For example, the network owner may receive 25% of the incentive given to the consumer.

In embodiments of the present invention, consideration may be given to reducing threats to the integrity of the advertising network 200. For example, a consumer 210 may desire to receive multiple incentives from advertisers by manipulating a user profile in order to mislead the advertisers into thinking the consumer has a desired profile. This may be a problem because the consumer is not legitimately interested in any advertised product or service and the advertisers may be wasting assets by targeting such false consumers. Accordingly, the network 200 may implement a variety of defenses to prevent or minimize the occurrence of this type of practice, which may dilute the effectiveness of the advertising. For example, the network 200 may cap the amount of incentives that a consumer is able to receive per time period (e.g., hour, day, week, or month). In some embodiments, the target profile of advertisement message 204 may require that consumers 210 actually have made purchases of a product, may require a highly specific set of target consumer activities, may require the profile not be of excessive size, or the like. Furthermore, consumers 210 may be required to view the advertisement and input certain information before they can receive the incentive offered. Further still, methods of accessing advertisements that prevent computer automated accesses may be implemented (e.g., Turing tests, which distinguish between human and computer interaction).

Another solution may involve each consumer computer 211 having multiple versions of the consumer profile. For example, one version may be plain text, and the other may be a hashed or encrypted version of the profile. In this embodiment, the hashed version may be a one-way global function accessible by anyone. The target profiles may be sent in hashed form also, and compared against the hashed version of a consumer profile. Only if a match occurs may the plain text of the target profile be determined. A hashed value in a location of hashed profile may correspond to a plain text value in the plain text version at the same relative location. If no match of hashed values occurs, then the plain text value may be undeterminable (because there is no matching entry in the hashed profile database). This solution may inhibit hackers and malicious users, by requiring they actually perform the activities required by a target profile before viewing an advertisement and receiving an incentive.

Advertisers 202 also may threaten the integrity of the network 200. For example, an advertiser 202 may try to discover information and identities about the consumers 210. Accordingly, the communications network 208 may help to ensure that the advertisement messages 204 do not contain web bugs that comprise, for example, programs written to allow an advertiser 202 to match an Internet Protocol (IP) address with the fact that a target profile matched a consumer profile associated with that address. This type of web bug may reduce consumer privacy. Preventing web bugs as described above may be accomplished by examining the advertisement messages 204 before they are broadcast and destroying any advertisement messages 204 that include web bugs or other detrimental programs.

Other considerations relevant to the network 200 may include limiting the cost of advertising using the network 200. For example, some advertisers 202 may not want to pay an unknown quantity of incentives to consumers. Limiting advertiser expense may be accomplished by one or more methods including, but not limited to, capping the number of matching customers that will receive an incentive, sampling a small percentage of the overall population of an area and estimating the result of an advertisement from the sampling, using a peer-to-peer architecture to estimate the number of matching consumers, implementing Internet voting protocols, or the like.

In embodiments of the present invention, the disclosed advertising technique may comprise querying multiple consumers to determine involvement. A problem may arise regarding such queries in some embodiments of the present invention because certain consumers may wish to change their user profiles (e.g., change previous answers) once they have seen the exact queries. For example, once a first user has been paid for viewing an ad and/or has recognized the targeting query of a particular ad, the first user may be tempted to tell other users how to obtain benefits from the ad. Based on information provided by the first user, other users may alter their respective profiles in order to obtain the benefits associated with receiving the same advertisement. In other words, users that are not truly interested in the advertisement and that do not actually have the desired profile may benefit from abuse of embodiments of the present invention. This type of activity may dilute the targeting of ads and lower value to advertisers. Accordingly, embodiments of the present invention may address this problem by arranging procedures such that users are effectively queried simultaneously. This may be achieved by requiring all participating user computers to commit to a profile by a particular time. In some embodiments of the present invention, queries may be broadcasted only after participating user computers have committed. Accordingly, by the time a user learns of a query, it may be too late to change the user's profile to match the query.

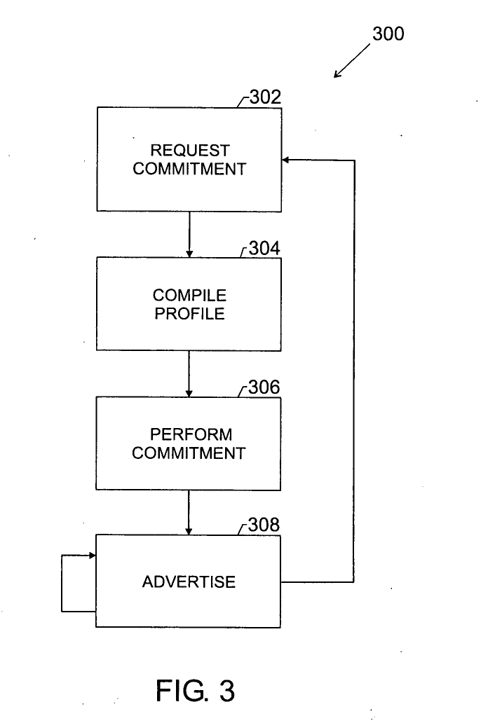

FIG. 3 shows a process flow diagram illustrating a method 300 for advertising in accordance with embodiments of the present invention. Specifically, as shown in FIG. 3, the method may comprise requesting a commitment (block 302), compiling a profile (block 304), performing a commitment (block 306), and advertising (block 308).

Regarding block 302, a coordinator (i.e., entity performing queries) may broadcast a message to participants, wherein the message includes a deadline for reply. For example, a commitment request may comprise a message stating, “Please commit to your profile by midnight tonight in order to participate.” Alternatively, this step may be omitted in favor of having prescheduled commitments.

As illustrated by block 304, each participating computer (i.e., “participant”) may compile a profile. In one embodiment of the present invention, as discussed above, the profile or portions of the profile may be committed to (block 306). This profile may be generated upon receiving the coordinators broadcast (block 302). Alternatively, the profile may already exist, having been incrementally constructed over time. For example, as previously explained with regard to FIG. 1, a consumer profile may be generated and used to organize consumer data such as that collected on a local computer. In some embodiments of the present invention, the profile comprises a set of features that the coordinator knows will be used to answer a query that will be performed in the advertising step of block 308.

Block 306 in FIG. 3 illustrates a commitment in accordance with embodiments of the present invention. In some embodiments of the present invention, a commitment may relate to committing to a set of information such as a user profile. For example, a participant may use a commitment process to commit to values of a user profile at a particular time. Such a commitment process may be designed such that the committed values may not be changed later and such that it does not reveal the values to outside parties. Additionally, in such embodiments, a commitment process may be designed such that the participant is able to selectively reveal later all or only a portion of the committed information via a proof that is convincing to other parties (in particular, the coordinator).

In some embodiments of the present invention, a device such as a TCP (Trusted Computing Platform) device may be present in a participant computer and may be utilized in the commitment process. Such a device (e.g., TCP device) may perform a commitment by storing a copy of a profile or portions of a profile along with the current time in a secure fashion. When asked for a proof revealing that the committed profile matches a query Q, the device may produce a digitally signed statement (e.g., a statement with an attached digital signature or digital code that uniquely identifies the sender) to the effect that the profile committed at time (save time) matches the query Q.

Alternatively, some embodiments of the present invention may utilize commitment functions in, for example, software applications. An exemplary commitment function method is discussed in S. Micali, M. O. Rabin and J. Kilian, Zero-Knowledge Sets, The Proceedings of the 44th Annual IEEE Symposium on Foundations of Computer Science (2003) (hereinafter the ZK set commitment method), which is hereby incorporated by reference. In some embodiments of the present invention, such embodiments may provide a commitment function that maps a profile to a small number called a hash. This result may look random to other parties yet the result depends on the entire contents of the profile in such a way that it is computationally infeasible to find another profile that maps to that same hash. Thus, by sending the result (sometimes referred to as a commitment) of one of these commitment functions applied to a profile to the coordinator, a participant can commit to that profile. These embodiments may also provide a procedure for generating proofs of the form “the profile whose hash (generated by the commitment function) is H matches query Q”. These proofs may contain no information other than the value H and query Q. If the coordinator receives such a proof after earlier receiving hash H at time T, it can be sure that the commiter's profile at time T matched query Q.

In block 306, as discussed above, each participant may use a commitment method such as the ZK set commitment method, sending a hash to the coordinator for use in later confirmation of the associated profile. Upon receiving such commitments, the coordinator may save the identity and commitment of each participant that replies in a timely fashion (i.e., before a deadline). Replies received by the coordinator after a deadline has passed may be ignored (e.g., discarded) by the coordinator. The coordinator may then use stored profile commitments to confirm that changes have not been made by users after queries have been sent (block 308).

After the deadline arrives, the coordinator may advertise (block 308) by, for example, sending targeted ads including queries to all of the participants as discussed regarding FIG. 1. It should be noted that multiple advertisements may be sent between commitments despite the fact that the most recently committed profile may become stale (i.e., out of date) because performing frequent commitments may be inconvenient or impractical. Participants receiving a targeted ad may evaluate each of the received queries against its profile. In accordance with some embodiments of the present invention, a query may be any function of a profile whose success can be demonstrated by a proof that a particular small subset of features belongs to the profile (i.e., positive features) combined with a proof that a particular small subset of features does not belong to the profile (i.e., negative features). There may be many different ways to demonstrate the success of a query. For example, a query might be “the user has visited a URL starting with www.merchant.com.” This is effectively an infinite “OR” because any URL starting with www.merchant.com (e.g., www.merchant.com/order) demonstrates success.

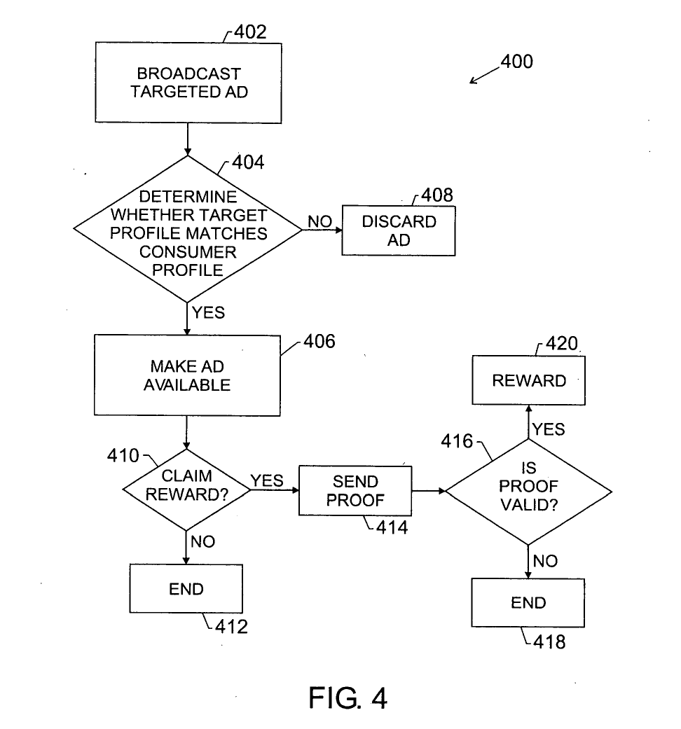

FIG. 4 shows a process flow diagram illustrating a method 400 for advertising in accordance with embodiments of the present invention. Specifically, FIG. 4 may represent further details of block 308 in FIG. 3. Block 402 represents broadcasting a targeted ad (advertisement message). As described in FIG. 2, a targeted ad may comprise a query (e.g., a target profile) and an advertisement. If the target profile matches the committed consumer profile (e.g., the query is satisfied by the committed profile), as determined in block 404, an advertisement may be made available to the consumer (block 406). Otherwise, the targeted ad may be discarded (block 408).

Block 410 represents determining whether a user chooses to claim a reward for viewing the targeted ad. If a participant's user does not wish to reveal a match, the process may end (block 412). For example, a user may not wish to relinquish his/her privacy by revealing the aspects of his/her profile that allowed him/her to view the ad. However, if a participant's user wishes to reveal that his/her profile matches a query, his/her computer may choose a means of demonstrating this, as represented by block 414. For example, the computer may construct a proof that his/her committed profile has the required positive features and is missing the specified negative features using methods such as those discussed above (e.g., ZK set commitment method). The computer may then send the proofs to the coordinator (block 414). Aspects of block 414 may be performed by hardware, software, or some combination thereof.

When the coordinator receives a proof, such as that described above, from a participant, the coordinator may verify the proof (block 416) against the commitment received (during the perform commitment step in block 306) from the same respective participant prior to the query. If verification fails, the process may end (block 418). If verification succeeds (i.e., the committed profile matches the query), the coordinator may mark the participant's profile as matching the query. This would result in the verified participant's user being paid or otherwise rewarded (block 420) in accordance with embodiments of the present invention as discussed above. It should be noted that in accordance with embodiments of the present invention, a system may be used wherein a party can commit to a collection of data features and then later prove aspects relating to the features without revealing private or additional information.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A method of directed communication, comprising:
sending targeted information to at least one of a plurality of computers, wherein the targeted information comprises a query;
receiving a proof after sending the targeted information, wherein the proof relates to an earlier commitment of a profile of data stored on one of the plurality of computers; and
using the proof to determine that the committed profile satisfied the query.

2. The method of claim 1, comprising paying a user of the one of the plurality of computers to allow the targeted information to be displayed to the user if the committed profile satisfies the query.

3. The method of claim 1, comprising confirming that the proof is from a trusted device.

4. The method of claim 1, wherein the proof is produced by a ZK set commitment method.

5. The method of claim 1, comprising receiving a hash from at least one of the plurality of computers, wherein the hash relates to the profile.

6. The method of claim 1, comprising broadcasting a message requesting a commitment from each of the plurality of computers.

7. The method of claim 6, wherein the message includes a deadline for response.

8. The method of claim 1, comprising receiving the earlier commitment and accepting the earlier commitment only if a condition relating to receiving the earlier commitment is met.

9. The method of claim 8, comprising accepting the earlier commitment only if a deadline for receiving the earlier commitment is met.

10. The method of claim 1, comprising sending a bid price to the plurality of computers, the bid price representing a reward to a user for allowing the targeted information to be displayed.

11. The method of claim 10, comprising comparing the bid price with an ask price and enabling the targeted information based on the comparison.

12. A method of directed communication, comprising:
collecting data on a computer;
performing a commitment relating to the data;
receiving a message containing criteria;
testing the criteria against the data;
making information available on the computer if the data satisfies the criteria; and
sending a proof relating to the data and commitment after receiving the message, the proof being for proving the criteria was met.

13. The method of claim 12, comprising receiving a broadcast containing a deadline for performing the commitment.

14. The method of claim 13, comprising performing the commitment within a time established by the deadline.

15. The method of claim 12, comprising receiving a payment if the proof is satisfactory.

16. The method of claim 12, wherein the message contains a bid price that indicates a maximum amount that a sending party will pay a receiving party for viewing the message.

17. The method of claim 12, comprising making the message available on the computer if the data satisfies the criteria and if the bid price of the message is greater than or equal to a consumer ask price.

18. A system for providing information, comprising:
a computer for collecting data;
a committing module adapted to performing a commitment relating to the data;
a receiving module adapted to receive a targeted message containing criteria;
a testing module adapted to test the criteria against the data;
a matching module adapted to make an advertisement a message available on the computer if the data satisfies the criteria; and
a proof module adapted to send a proof relating to the data after receiving the targeted message, the proof being for proving the criteria was met.

19. The system of claim 18, wherein the data comprises a log of activities performed by the computer.

20. The system of claim 18, wherein the criteria comprises a set of target consumer activities.

21. The system of claim 18, wherein the data comprises a log of activities associated with television channels.

22. The system of claim 18, wherein the data comprises a consumer ask price indicative of an amount a first entity is willing to take in exchange for viewing the targeted message and the criteria comprises a bid price indicative of an amount a second entity is willing to give the first entity for viewing the targeted message.

23. The system of claim 18, wherein the commitment produces a hash relating to the data.

24. A computer, comprising:
a display;
a CPU;
memory coupled to the CPU; and
an instruction storage medium coupled to the CPU, the instruction storage medium providing instructions executable by the CPU, whereby the computer logs user activities, creates a local user profile based on said user activities, performs a commitment based on the local user profile, and displays information on the display if a query of a targeted message is satisfied by the local user profile.

25. A system for advertising, comprising:
means for receiving a targeted message, the targeted message having display information capable of enablement and target criteria for testing against a profile, the profile relating to compiled data;
means for committing to the profile before enabling the display information;
means for testing the target criteria against the profile with the target criteria;
means for enabling the display information if the profile meets the target criteria; and
means for sending a proof that the criteria was met.

26. The system of claim 25, comprising means for providing payment to a user when the proof verifies successfully.

27. A computer program, comprising:
a tangible medium;
a collection module stored on the tangible medium, the collection module for collecting data;
a committing module stored on the tangible medium, the committing module adapted for performing a commitment relating to the data;
a receiving module stored on the tangible medium, the receiving module adapted to receive a communication containing criteria;
a testing module stored on the tangible medium, the testing module adapted to test the criteria against the data with the criteria;
a matching module stored on the tangible medium, the matching module adapted to make information available on a computer if the data matches the criteria; and
a proof module stored on the tangible medium, the proof module adapted to send a proof relating to the data after receiving the communication, the proof being for proving the criteria was met.

28. The computer program of claim 27, wherein the data comprises a log of activities performed by the computer.

29. The computer program of claim 27, wherein the data comprises a log of activities associated with televisions channels displayed.

30. The computer program of claim 27, wherein the data comprises a log of activities associated with a software application used on the computer.

31. The computer program of claim 27, wherein the data comprises an ask price indicative of a price required for a first entity to view the information and the criteria comprises a bid price indicative of the price a second entity is willing to pay the first entity for viewing the information.

32. The method of claim 1, wherein the targeted information is an advertisement.

33. The method of claim 12, comprising reducing privacy loss by employing a local secure interface.

34. The method of claim 12, wherein the information is an advertisement.

35. The system of claim 18, comprising a local interface module that is adapted to preserve privacy during testing of the criteria against the data.

36. The system of claim 18, wherein the message is an advertisement.

37. The computer of claim 24, wherein the information is an advertisement.

38. The computer program of claim 27, comprising a local interface module that is adapted to preserve privacy during testing of the criteria against the data.

39. The computer program of claim 27, wherein the information is an advertisement.
